(19) United States
(12) Patent Application Publication
(10) Pub. No.: US 2021/0302068 A1
(43) Pub. Date: Sep. 30, 2021

(54) PTC Heater with Energy Save Function

(71) Applicant: World & Main (Cranbury) LLC, Cranbury, NJ (US)

(72) Inventor: John H. Bavoso, Hamilton Square, NJ (US)

(21) Appl. No.: 17/203,226

(22) Filed: Mar. 16, 2021

Related U.S. Application Data
(63) Continuation-in-part of application No. 17/202,161, filed on Mar. 15, 2021.
(60) Provisional application No. 63/002,951, filed on Mar. 31, 2020.
(60) Provisional application No. 63/002,958, filed on Mar. 31, 2020.
(60) Provisional application No. 63/002,965, filed on Mar. 31, 2020.

(51) Int. Cl. F24H 9/20; F24H 3/00; F24H 9/00; F24H 9/18

(52) U.S. Cl. CPC F24H 9/2071; F24H 3/002; F24H 2250/04; F24H 9/0073; F24H 9/1872; F24H 9/0057

(57) ABSTRACT

A heating appliance has electrical circuitry, a controller, a heating element, a temperature sensor, and a power selection switch having a varying power setting for enabling the user to select a varying power heating mode during which the room temperature is sensed by and if below a certain desirable temperature level, the controller causes higher power heating until the room temperature reaches the certain desirable temperature level and then causes lower power heating.

### FIELD OF THE INVENTION

The present invention is related to heating appliances. More specifically, it is related to circuitry for portable electric room heaters.

### BACKGROUND

Portable electric room heaters are well known. Such heaters typically draw 1500 W of electricity and convert that to heat because 1500 W is the maximum allowed by any unattended and continuously operating electrical appliance. Such heat may quickly warm a small room, so to avoid wasting energy once the room is satisfactorily warm, many such heaters employ a thermostat to de-energize the heater once a desired room temperature is realized and re-energize it once a certain lower temperature is realized.

A drawback in such an arrangement is that such thermostats will always have some degree of hysteresis, so the room temperature typically cycles from a temperature below desired to the temperature desired, which creates discomfort.

A user may overcome this drawback by operating the heater on a higher wattage setting until the room is satisfactorily warm, then turning the heater down to a lower wattage setting to maintain the desired temperature without such cycling, but such manual attention is inconvenient and oftentimes not possible.

There exists a need for, and it is an object of the invention to provide, a heating appliance that operates at a higher wattage setting until a desired temperature is reached or until a certain time period has passed, and then automatically changes its setting to a lower wattage setting to both save energy and increase comfort.

Further needs and objects exist which are addressed by the present invention, as may become apparent upon review of the included disclosure of exemplary embodiments thereof.

### SUMMARY OF THE INVENTION

The invention may be embodied in or practiced using an electrical heating appliance having improvements which may include an energy-saving heat setting which causes the heater to operate at a higher wattage setting for a period of time or until a desired room temperature is realized, and to then automatically change to operate at a lower wattage setting.

The invention may be embodied in or practiced using a heating appliance having electrical circuitry, a controller connected to the electrical circuitry, a heating element connected to the electrical circuitry and adapted for a higher power heating and a lower power heating, a temperature sensor connected to the electrical circuitry and adapted to measure room temperature, and a power selection switch connected to the electrical circuitry and having a varying power setting for enabling the user to select a varying power heating mode during which the room temperature is sensed by the temperature sensor and if below a certain desirable temperature level, the controller causes the higher power heating until the room temperature sensed by the temperature sensor reaches the certain desirable temperature level and then causes the lower power heating. The lower power heating may be not powerless.

The power selection switch may have a low power setting in which the controller causes the low power heating and a high power setting in which the controller causes the high power heating.

The heating appliance may have a temperature selection switch for enabling the user to select a desired room temperature such that the heating element becomes unpowered once the selected desired room temperature is sensed when the power selection switch is one of the low power setting and the high power setting.

The heating element may be a PTC heating element. The PTC heating element may be an array of PTC chips embedded within a porous heat exchanging radiator. The heating appliance may have a fan adapted to force room air through the porous heat exchanging radiator wherein the room air extracts heat therefrom to create heated air, and to force the heated air from the heating appliance. The heating appliance may have marking adjacent the power selection switch which indicates that the varying power setting is an energy-saving setting.

Further features and aspects of the invention are disclosed with more specificity in the Detailed Description and accompanying drawings of an exemplary embodiment provided herein.

### BRIEF DESCRIPTION OF THE DRAWINGS

Many aspects of the invention can be better understood with reference to the included Drawings showing an exemplary embodiment for practicing the invention which corresponds to the accompanying Detailed Description. The components in the Drawings are not necessarily to scale, emphasis instead being placed upon clearly illustrating the principles of the invention. Moreover, like reference numerals in the Drawings designate corresponding parts throughout the several views.

FIG. 1 is a perspective view of a portable electric heating appliance according to or for use in practicing the invention;

FIG. 2 is a front view of the appliance of FIG. 1;

FIG. 3 is a top view showing the controls of the appliance of FIG. 1;

FIG. 4 is a full side cross section of the appliance of FIG. 1;

FIG. 5 is an exploded view of the appliance of FIG. 1;

FIG. 6 is a perspective view of the heating element array of the appliance of FIG. 1;

FIG. 7A is a circuit diagram of the appliance of FIG. 1;

FIG. 7B is a circuit diagram of the appliance of FIG. 1;

FIG. 8 is an image of the operating instructions for the appliance of FIG. 1; and

FIG. 9 is an operational flow chart for the appliance of FIG. 1.

### DETAILED DESCRIPTION OF AN EXEMPLARY EMBODIMENT

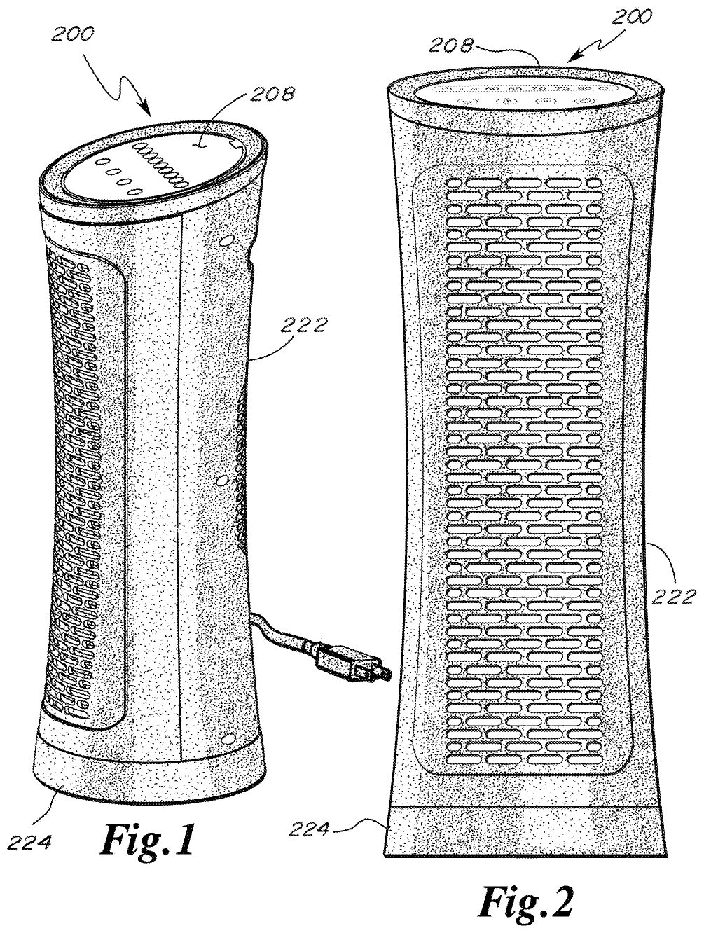

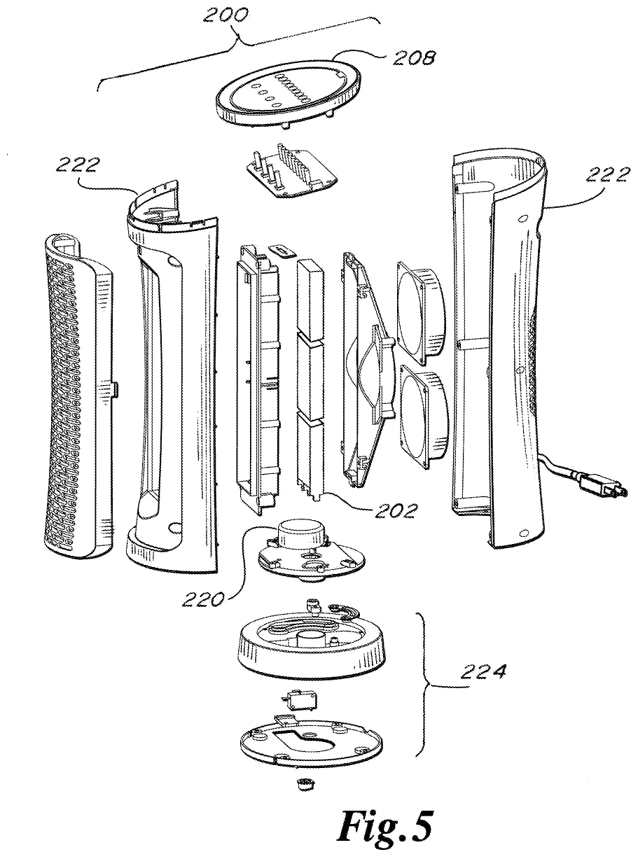

A room air heating appliance 200 is shown in FIGS. 1 through 9, which has a positive thermal coefficient (PTC) heating element array 202. The heating appliance may have any one of many shapes, configurations, and control panel arrangements, with those shown being merely exemplary as shown throughout the accompanying images.

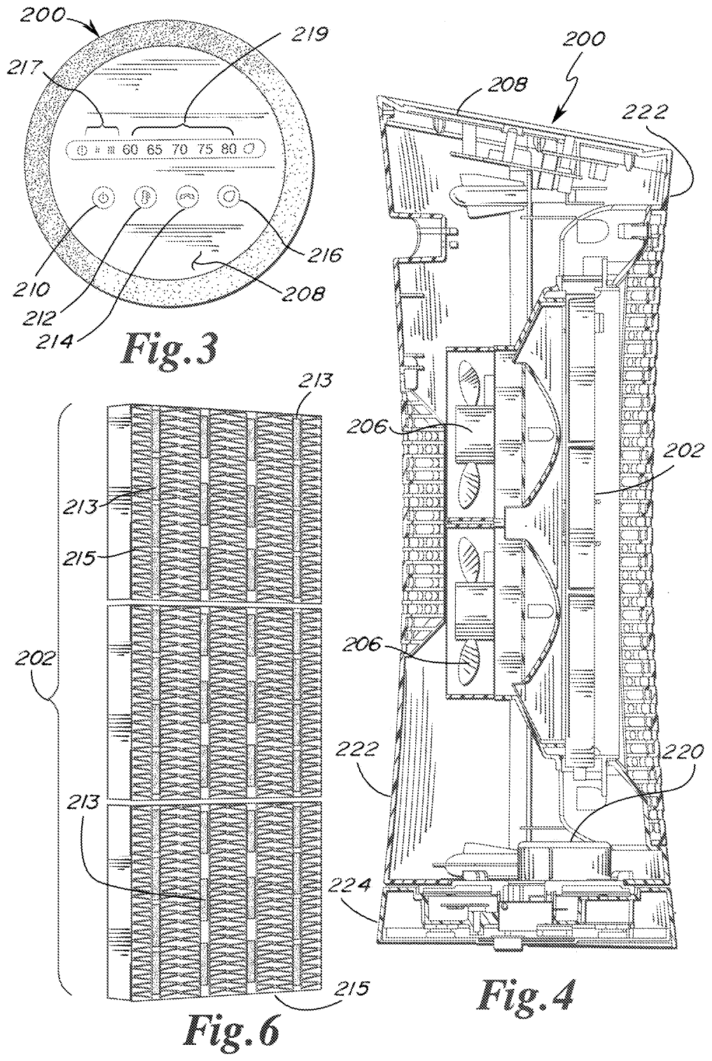

Control panel 208, seen best in FIG. 3, has an On/Off/Power switch 210, a Temperature Selection switch 212, an Oscillation switch 214, and an Energy Save Switch 216.

Referring to FIG. 6, the heating element array includes three vertically-stacked PTC arrays having PTC chips 213 imbedded within porous heat-exchanging radiators 215. It is the nature of the PTC chips that a voltage there-across will cause the chip to become hot, and that heat will conduct to the heat radiator/radiators with which it is in contact. Fans 206 force air through the porous radiators to extract the heat therefrom whenever one or more of the PTC chips are energized, then forces that air forwardly from the appliance and into the surrounding environment.

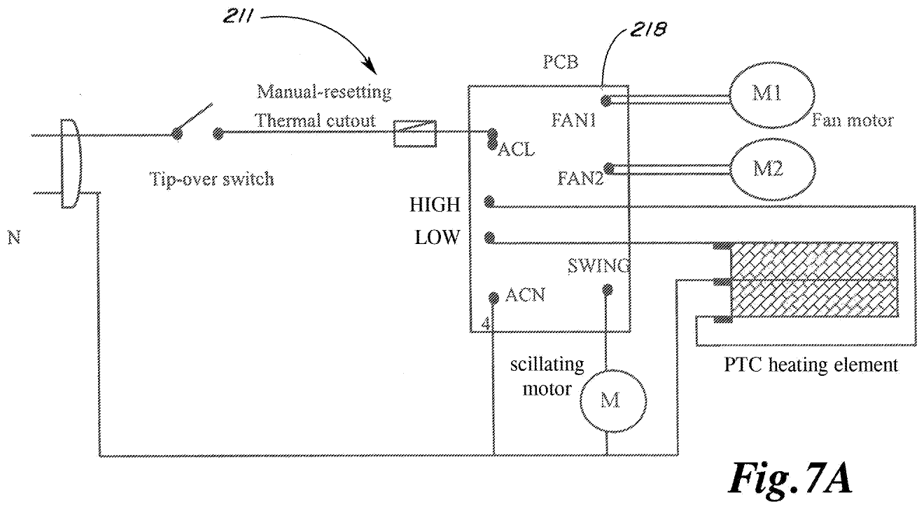

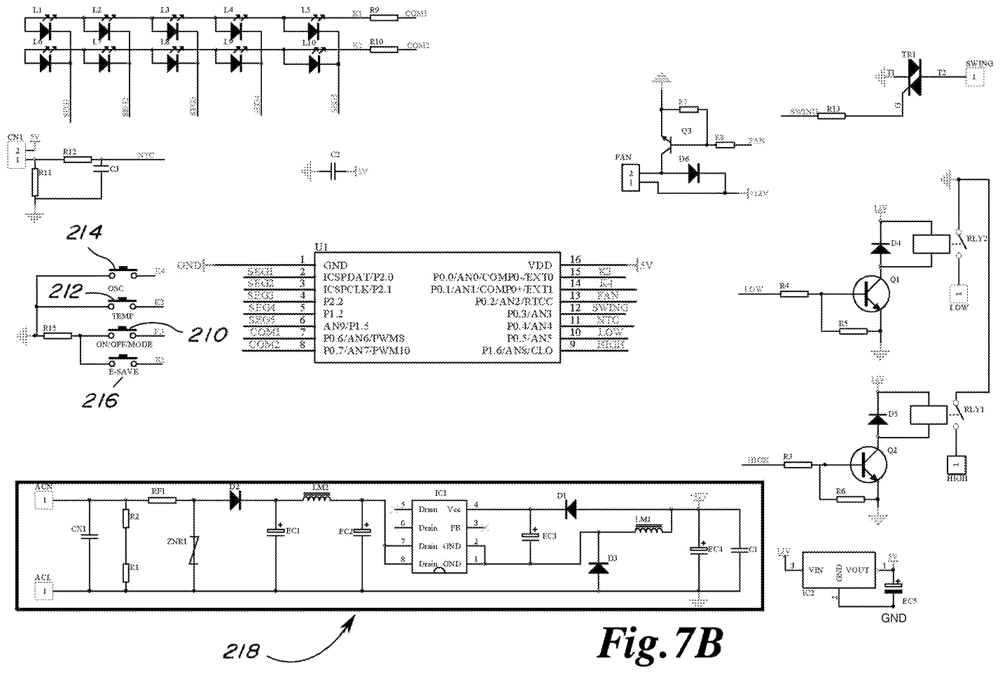

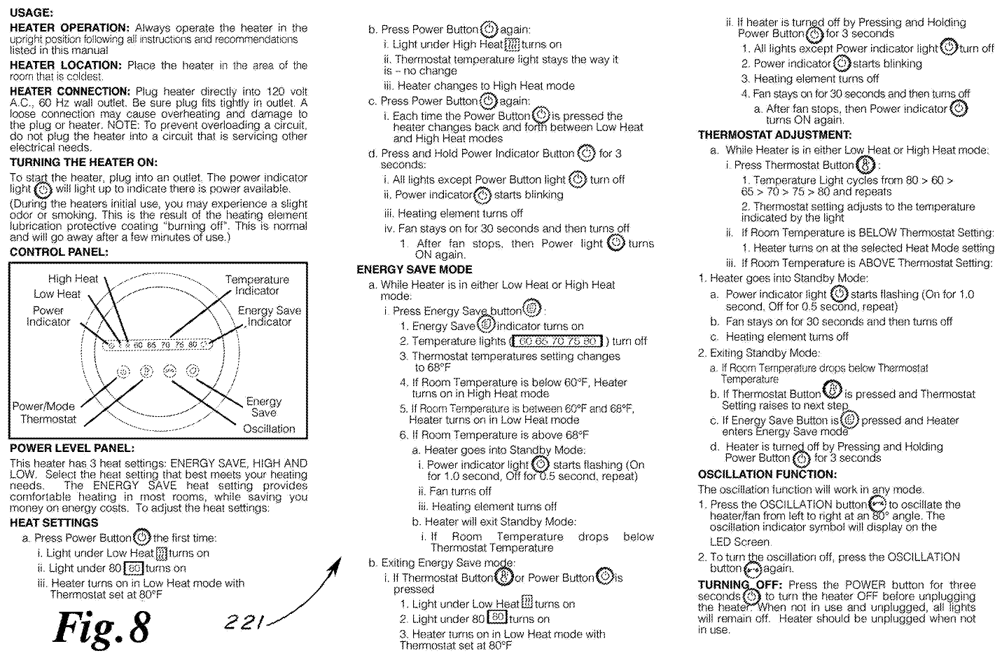

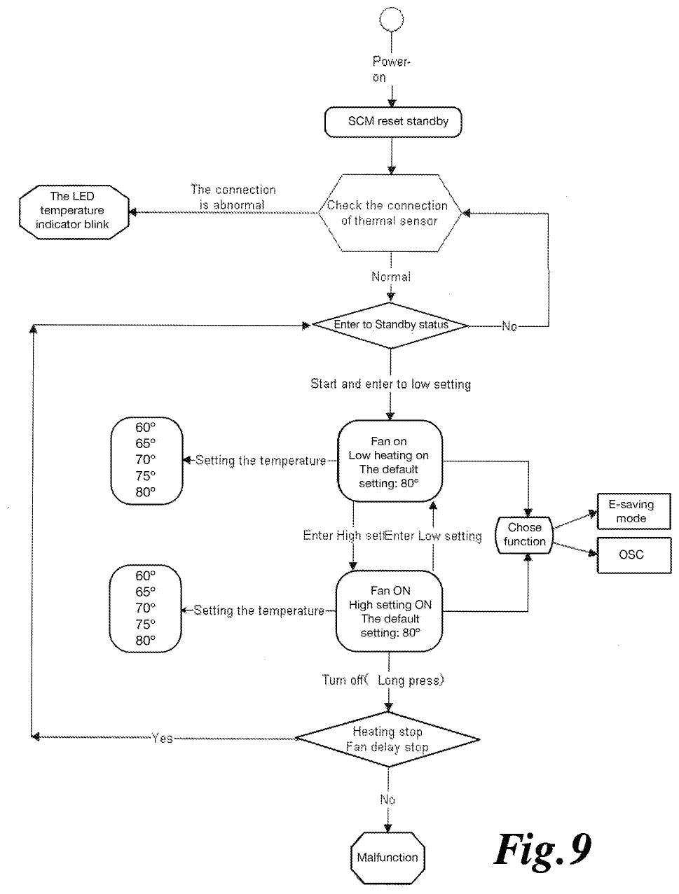

The electrical circuitry 211 for the heater is shown in FIG. 7A and the circuitry for the PC Board 218 is shown in FIG. 7B. FIG. 8 is an image of the user instructions 221 for the heater. And FIG. 9 is the heater's operational flow chart.

Pressing the On/Off/Power switch once energizes the fan and the heating element at low power. Pressing the On/Off/Power switch a second time increases the heating element to high power. Further pressing toggles between high and low power. Indicator lamps 217 indicate the operating power level and indicator lamps 219 indicate the chosen desired room temperature. The heater will operate at the chosen setting until the desired room temperature is realized and will then shut off temporarily until a room temperature a few degrees below desired is sensed, then it will cycle on and off that way continuously.

Pressing the Oscillation switch turns on or off a motor 220 that causes the heater housing 222 to oscillate back and forth relative to its base 224 to broadcast heat over a wider range.

Pressing the Energy Save switch initiates the energy-saving mode in which the desired room temperature is automatically set at 68 F. If the existing room temperature is below 60 F, the heater is automatically energized at high power. If the existing room temperature is between 60 F and 68 F, then the heater is automatically energized at low power. The heater continuously adjusts its power output once 68 F is realized to maintain the temperature at 68 F with no hot/cold cycling.

In the case where the room temperature is already above 68 F when the Energy Save setting is enacted, the heater goes into a sleep mode and the heating elements are not energized until the temperature drops a measurable level below 68 F. Thereafter the heater continuously adjusts its power output to maintain the temperature at 68 F with no hot/cold cycling.

While the heater described above cycles between high power and low power during Energy Save mode, it could alternatively be arranged to cycle between any higher power and any lower power operation (such as High and Medium, or Medium and Low).

And while the heater described above will operate in at the higher setting until the desired room temperature is realized and then reduce its power it may alternative employ a timer and be arranged to operate at the higher setting for a period of time and then reduce its wattage. Operation between the higher and lower settings continuously is found to be far more comfortable and to eliminate hot/cold cycling compared to employing a thermostat.

The system described employs an electric touch pad control, but may alternatively have a rotary dial that, when turned, scrolls through various temperature settings and then Energy-Save.

Various changes in form and detail may be made without departing from the spirit and scope of the invention, so the invention should therefore only be considered according to the following claims, including all equivalent interpretation to which they are entitled.

1. A heating appliance comprising;
electrical circuitry;
a controller connected to the electrical circuitry;
a heating element connected to the electrical circuitry and adapted for a higher power heating and a lower power heating;
a temperature sensor connected to the electrical circuitry and adapted to measure room temperature; and
a power selection switch connected to the electrical circuitry and having a varying power setting for enabling the user to select a varying power heating mode during which the room temperature is sensed by the temperature sensor and if below a certain desirable temperature level, the controller causes the higher power heating until the room temperature sensed by the temperature sensor reaches the certain desirable temperature level and then causes the lower power heating; and
wherein the lower power heating is not powerless.

3. The heating appliance of claim 1 wherein the power selection switch further has a low power setting in which the controller causes the low power heating and a high power setting in which the controller causes the high power heating.

4. The heating appliance of claim 2 further comprising a temperature selection switch for enabling the user to select a desired room temperature such that the heating element becomes unpowered once the selected desired room temperature is sensed when the power selection switch is one of the low power setting and the high power setting.

5. The heating appliance of claim 4 in which the heating element is a PTC heating element.

6. The heating appliance of claim 5 in which the PTC heating element is an array of PTC chips embedded within a porous heat exchanging radiator.

7. The heating appliance of claim 6 further comprising a fan adapted to force room air through the porous heat exchanging radiator wherein the room air extracts heat therefrom to create heated air, and to force the heated air from the heating appliance.

8. The heating appliance of claim 7 further comprising marking adjacent the power selection switch which indicates that the varying power setting is an energy-saving setting.

9. The heating appliance of claim 1 further comprising marking adjacent the power selection switch which indicates that the varying power setting is an energy-saving setting.

10. The heating appliance of claim 4 further comprising marking adjacent the power selection switch which indicates that the varying power setting is an energy-saving setting.
